(19) United States
(12) Patent Application Publication
(10) Pub. No.: US 2024/0335963 A1
(43) Pub. Date: Oct. 10, 2024

(54) MAGNETIC NOSE HAIR DEVICE

(71) Applicant: Weixiang HUANG, Ganzhou (CN)

(72) Inventors: Weixiang HUANG, Ganzhou (CN); Yiwen CHEN, Ganzhou (CN); Shijia CHEN, Ganzhou (CN)

(73) Assignee: Weixiang HUANG, Ganzhou (CN)

(21) Appl. No.: 18/736,172

(22) Filed: Jun. 6, 2024

(30) Foreign Application Priority Data
Apr. 6, 2023 (CN) 2023103840255

(51) Int. Cl. B26B 19/14; B26B 19/38

(52) U.S. Cl. CPC B26B 19/148; B26B 19/386

(57) ABSTRACT

The present disclosure provides a magnetic nose hair device, which includes a cutter head and a main body. The cutter head includes a cutter head housing. A cavity is provided inside the cutter head housing. A bottom of the cutter head housing is arranged with a first magnetic piece, a top of the main body corresponding to the position of the first magnetic piece is arranged with a second magnetic piece. The cutter head and the main body are detachably connected through the magnetic attraction of a first magnetic piece and a second magnetic piece. The cutter head and the main body are connected magnetically, which is easy and does not require precise alignment. The cutter head and the main body of the magnetic nose hair device of the present disclosure is more convenient to mount and disassemble, and is more convenient to clean after use.

### CROSS-REFERENCE TO RELATED APPLICATIONS

This application claims priority benefits to Chinese Patent Application No. 2023103840255, filed Apr. 6, 2023, the contents of which are incorporated herein by reference.

### TECHNICAL FIELD

The present disclosure relates to the technical field of nose hair devices, and in particular, to a magnetic nose hair device.

### BACKGROUND

A nose hair trimming device partially extends a cutter head into an user's nasal cavity to cut the nose hair into pieces and drops them into a storage cavity of the trimming device. After trimming, the user removes the cutter head and cleans the nose hair fragments inside the storage cavity. A snap-in connection is mostly adopted between the cutter head and the body of the nose hair trimming device. Some snapping parts are relatively narrow and difficult to be cleaned, and the snap-in connection way needs to be accurately aligned with the snapping position when mounting, which is relatively laborious.

### SUMMARY

A magnetic nose hair device includes a cutter head and a main body. The cutter head includes a cutter head housing, and a bottom of the cutter head housing is provided with a first magnetic piece, a top of the main body corresponding to the first magnetic piece is provided with a second magnetic piece, and the cutter head and the main body are magnetically and detachably connected together through the first magnetic piece and the second magnetic piece.

### BRIEF DESCRIPTION OF DRAWINGS

The description and drawings are provided for a further understanding of the present disclosure. The illustrative embodiments and their descriptions are to explain the present disclosure and do not constitute an improper limitation of the present disclosure.

FIG. 1 is a schematic structural view according to an embodiment.

FIG. 2 is a schematic exploded structural view according to an embodiment.

FIG. 3 is a schematic cross-sectional structural view of a cutter head according to an embodiment.

FIG. 4 is a schematic cross-sectional structural view of a connection part between a cutter head and a main body according to an embodiment.

FIG. 5 is a schematic structural view of a cutter head, a filter and a main body separated with each other according to an embodiment.

FIG. 6 is a schematic structural view of a blade cover illustrated in FIG. 2 according to an embodiment.

Reference signs: 1—cutter head; 11—cutter head housing; 110—cavity; 111—first magnetic piece mounting groove; 12—blade cover; 13—inner cutting knife; 14—first magnetic piece; 2—main body; 20—rotating shaft; 21—fastening piece; 22—second magnetic piece mounting groove; 23—second magnetic piece; 3—filter; 31—through hole.

### DETAILED DESCRIPTION OF THE EMBODIMENTS

The present disclosure will be described in detail below with reference to the accompanying drawings and embodiments. Each embodiment is provided to explain but not as a limitation of the present disclosure. It will be apparent to those skilled in the art that modifications and variations may be made in the present disclosure without departing from the scope or spirit of the present disclosure. For example, features shown or described as part of one embodiment may be used on another embodiment, to yield another embodiment. It is therefore intended that the present disclosure cover such modifications and variations as come within the scope of the appended claims and their equivalents.

In the description of the present disclosure, orientations or positional relationships indicated by terms “longitudinal”, “transversal”, “upper”, “lower”, “front”, “back”, “left”, “right”, “vertical”, “horizontal”, “top”, “bottom”, etc., are based on the orientations or positional relationships shown in the drawings. They are only for the convenience of describing and do not require that the present disclosure must be constructed and operated in a specific orientation. Therefore, it cannot be understood as limitations on the present disclosure. Terms “connected”, “connecting” and “arranged” used herein should be understood in a broad sense. For example, it may be a fixed connection or a detachable connection; it may be a direct connection or an indirect connection through an intermediate component; it may be a wired electrical connection, a radio connection, or a wireless communication signal connection. For those skilled in the art, the specific meaning of the above terms may be understood according to the specific case.

One or more examples of the present disclosure are illustrated in the accompanying drawings. The detailed description uses numerical and letter signs to refer to features in the drawings. In the drawings and description, the reference signs have been used to refer to similar parts of the present disclosure. As used herein, terms “first,” “second,” “third” and the like are used interchangeably to distinguish one component from another and are not intended to denote the position or importance of individual components.

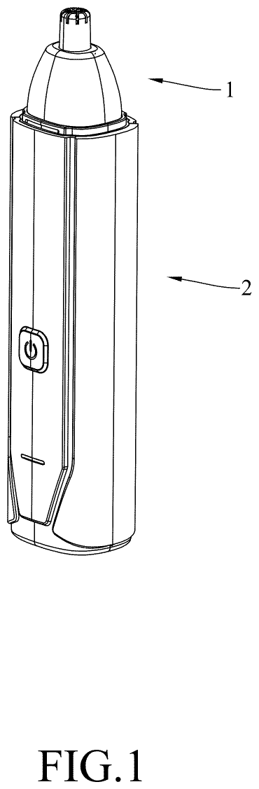

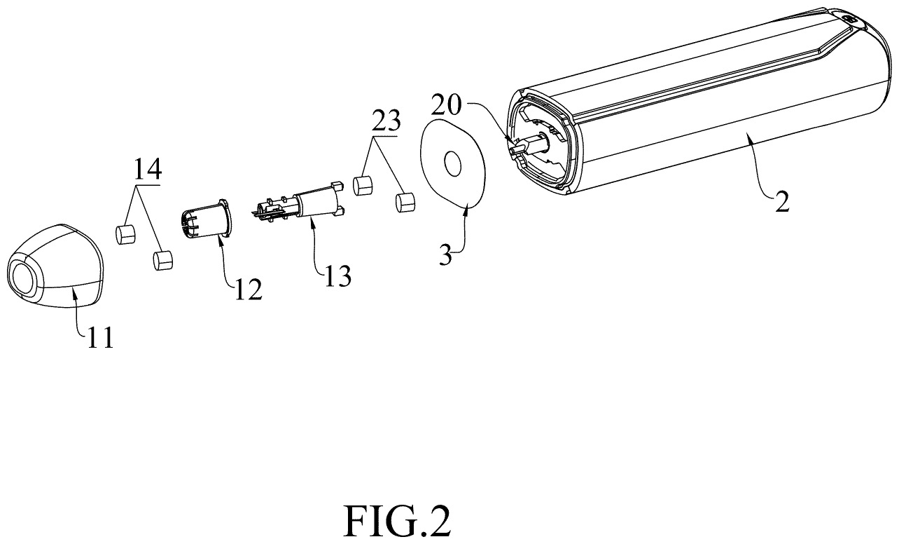

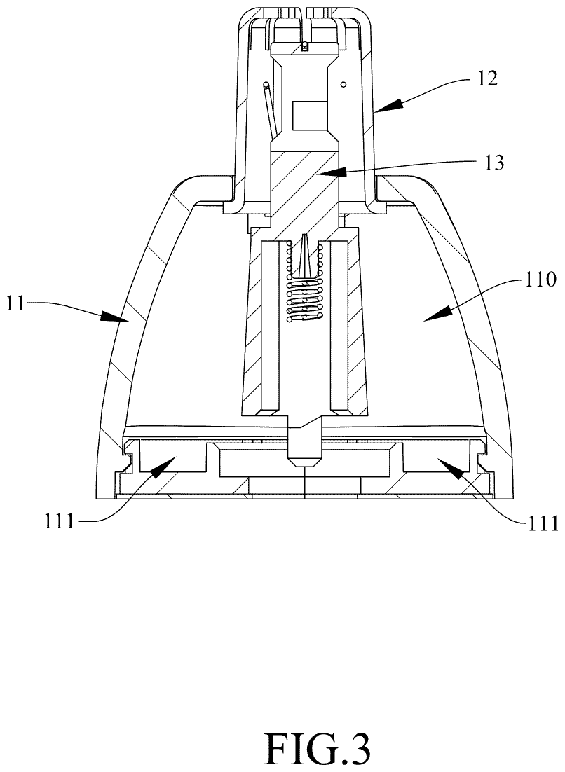

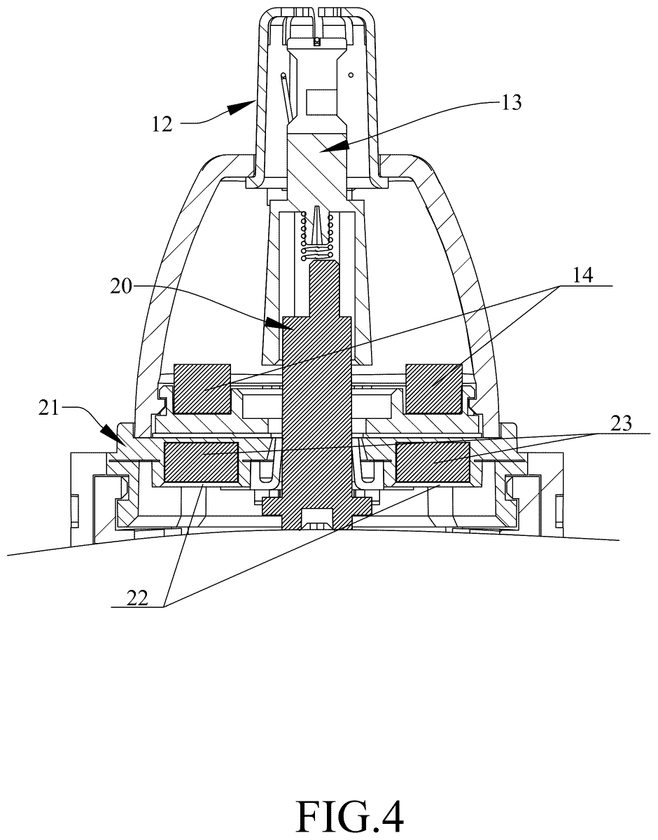

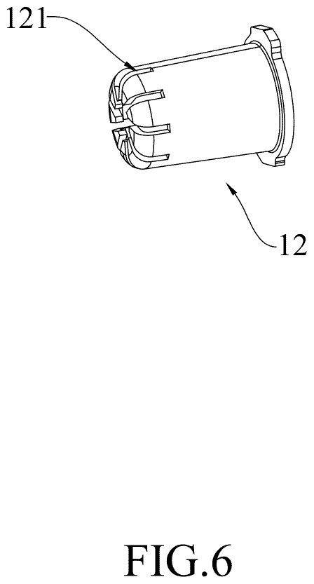

As shown in FIG. 1 to FIG. 6, according to an embodiment of the present disclosure, a magnetic nose hair device is provided. The magnetic nose hair device includes a cutter head 1 and a main body 2. The cutter head 1 includes a cutter head housing 11. A top and a bottom of the housing 11 are respectively provided with a through opening, and a cavity 110 is provided between the two through openings. A blade cover 12 is mounted at the through opening at the top of the cutter head housing 11. A plurality of slots 121 are defined in the blade cover 12 to facilitate nose hair to be stretched into the inside of the blade cover 12. An inner cutting knife 13 is mounted inside the blade cover 12. The inner cutting knife 13 rotates inside the blade cover 12 and cooperates with the blade cover 12 to cut off the nose hair that extends into the inside of the blade cover 12.

The main body 2 is provided with a rotating shaft 20 and a driving element for driving the rotating shaft 20 to rotate. An output end of the rotating shaft 20 extends out of a top of the main body 2 and is configured to connect with the inner cutting knife 13 of the cutter head 1 and drive the inner cutting knife 13 to rotate.

Two first magnetic piece mounting grooves 111 are provided at a lower part of the cutter head housing 11, and a first magnetic piece 14 is fixedly mounted inside each of the two first magnetic piece mounting grooves 111.

A top of the main body 2 corresponding to the two first magnetic piece mounting grooves 111 is provided with two second magnetic piece mounting grooves 22. A second magnetic piece 23 is fixedly mounted inside each of the two second magnetic piece mounting grooves 22. When the two first magnetic pieces 14 and the two second magnetic pieces 23 respectively attract each other, the cutter head 1 is attracted to the main body 2. In addition, a group of annular magnets may also be arranged between the cutter head 1 and the main body 2 to realize their magnetic connection. Similarly, the magnetic attraction way between the cutter head 1 and the main body 2 may also be realized by arranging multiple groups of magnetic pieces, such as three groups, four groups, etc. In addition, a group of magnetic pieces may also be a combination of two magnets, or a combination of magnets and ferromagnetic metals, which may also realize the magnetic function. No further details will be given in the embodiments.

In order to simplify the structure, the first magnetic piece mounting grooves 111 of the cutter head housing 11 in the present embodiment are provided at an edge of an inner wall of the cutter head housing 11, and the position of the first magnetic piece mounting grooves 111 are arranged as close to the edge as possible.

In order to facilitate the cleaning of the nose hair device after use, a fastening piece 21 is provided on a top of the main body 2, and a rotating shaft through hole is provided in a center of the fastening piece 21. After the rotating shaft 20 passes through the rotating shaft through hole, the fastening piece 21 and the main body 2 is detachably connected. A filter 3 is mounted inside the fastening piece 21. A through hole 31 is provided in a center of the filter 3 for the rotating shaft 20 to pass through. When the filter 3 is mounted on the fastening piece 21, the rotating shaft 20 passes through the fastening piece 21 and the filter 3 respectively. The fastening piece 21 is fixedly connected to the main body 2 and the filter 3 is placed at an upper end of the main body 2. When in use, the filter 3 is mounted inside the main body 2 and the rotating shaft 20 passes through the through hole 31. When the nose hair fragments enter the cavity 110, they fall downward onto the filter 3, which reduces the possibility of the nose hair fragments falling into the interior of the main body 2 and contaminating the internal electronic elements. In addition, the filter 3 collects the nose hair fragments. After cleaning, the filter 3 may be removed and the nose hair fragments may be cleaned before mounting. The filter 3 may also be disposable. After cleaning, the nose hair fragments are discarded together with the filter 3. After mounting the filter 3, the possibility of the nose hair fragments falling into the main body 2 is reduced, the interior of the main body 2 is kept clean and sanitary, and the nose hair device is made more convenient to clean after use.

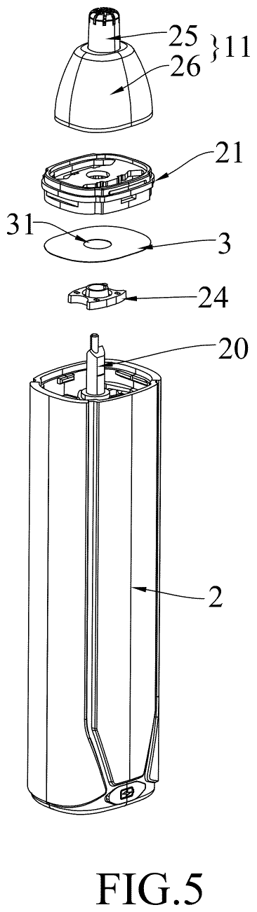

In some embodiments, as illustrated in FIG. 5, a supporting piece 24 is arranged between the fastening piece 21 and the main body 2. The supporting piece 24 may be configured to support the fastening piece 21 such that the fastening piece 21 may be stably positioned.

In some embodiments, as illustrated in FIG. 5, the cutter head housing 11 includes a first housing 25 and a second housing 26 connected with each other, at least a part of the inner cutting knife 13 extends inside the first housing 25. The first housing 25 and the second housing 26 may be integrated together into one piece.

In some embodiments, as illustrated in FIG. 5, a volume of the second housing 26 is greater than that of the first housing 25. For example, the first housing 25 may be in the shape of a cylindrical tube and its volume may substantially adapt to an user's nostril, and the second housing 26 may be in a conical shape and its volume is suitable for the user to hold.

In some embodiments, a magnetic nose hair device is provided. The magnetic nose hair device includes a cutter head 1 and a main body 2. The cutter head 1 includes an inner cutting knife 13, and the cutter head 1 is provided with a first magnetic piece 14, the main body 2 is provided with a second magnetic piece 22, and the cutter head 1 and the main body 2 are magnetically and detachably connected together through the first magnetic piece 14 and the second magnetic piece 22.

In some embodiments, as illustrated in FIG. 1 to FIG. 5, a magnetic nose hair device is provided, which includes a cutter head 1 and a main body 2. The cutter head 1 includes a cutter head housing 11 and an inner cutting knife 13. The cutter head housing 11 is provided with a first connecting piece, the main body 2 is provided with a second connecting piece, and the cutter head 1 and the main body 2 are detachably connected together through the first connecting piece and the second connecting piece. The first connecting piece and the second connecting piece match with each other to allow the cutter head 1 and the main body 2 to be detachably connected together. For example, the first connecting piece may be one of a screw and a nut, and the second connecting piece may be the other one of a screw and a nut. The first connecting piece and the second connecting piece may also be other structures which match with each other.

From the above description, it may be seen that the above-mentioned embodiments of the present disclosure achieve the following technical effects.
1. The cutter head 1 and the main body 2 are connected magnetically, which is easy to connect and does not require precise alignment to achieve precise connection.
2. The filter 3 is provided inside the main body 2, which may effectively reduce the possibility of the nose hair fragments falling into the main body 2, and make the nose hair device more convenient to clean after use. Compared with the related art, the magnetic nose hair device of the present disclosure is more convenient for the cutter head and the main body to mount and disassemble, and is more convenient to clean after use.

The above are only some embodiments of the present disclosure and are not intended to limit the present disclosure. For those skilled in the art, the present disclosure may have various modifications and changes. Any modifications, equivalent substitutions, improvements, etc. made within the spirit and principles of the present disclosure shall be included in the protection scope of the present disclosure.

What is claimed is:

1. A magnetic nose hair device, comprising a cutter head and a main body, wherein the cutter head comprises a cutter head housing, and a bottom of the cutter head housing is provided with a first magnetic piece, a top of the main body corresponding to the first magnetic piece is provided with a second magnetic piece, and the cutter head and the main body are magnetically and detachably connected together through the first magnetic piece and the second magnetic piece.

2. The magnetic nose hair device according to claim 1, wherein at least one of the first magnetic piece and the second magnetic piece is a magnet, and another one of the first magnetic piece and the second magnetic piece is a ferromagnetic metal.

3. The magnetic nose hair device according to claim 1, wherein the first magnetic piece and the second magnetic piece are both magnets.

4. The magnetic nose hair device according to claim 1, wherein two first magnetic pieces and two second magnetic pieces are arranged respectively, and
the two first magnetic pieces are arranged symmetrically at a bottom end of the cutter head housing along an axis of a bottom opening of the cutter head housing.

5. The magnetic nose hair device according to claim 1, wherein a first magnetic piece mounting groove is provided at a bottom end of the cutter head housing, and a top of the main body corresponding to the first magnetic piece mounting groove is provided with a second magnetic piece mounting groove, and the second magnetic piece mounting groove is provided with a second magnetic piece.

6. The magnetic nose hair device according to claim 1, wherein an upper opening of the cutter head housing is provided with a blade cover, an inner cutting knife is arranged inside the blade cover, a cavity is defined inside of the cutter head housing and below the inner cutting knife, a rotating shaft and a driving element for driving the rotating shaft to rotate are arranged inside the main body, and the rotating shaft extends out of a top of the main body and passes through the cavity to connect with the inner cutting knife to drive the inner cutting knife to rotate.

7. The magnetic nose hair device according to claim 6, wherein a filter is provided inside the main body, and a through hole for the rotating shaft to pass through is provided at a center of the filter.

8. The magnetic nose hair device according to claim 7, wherein the filter is disposable.

9. The magnetic nose hair device according to claim 5, the first magnetic piece mounting groove is provided at an edge of an inner wall of the cutter head housing.

10. The magnetic nose hair device according to claim 6, a fastening piece is provided on a top of the main body, and the filter is arranged inside the fastening piece.

11. The magnetic nose hair device according to claim 10, wherein a rotating shaft through hole is provided in a center of the fastening piece, the rotating shaft passes through the rotating shaft through hole to allow the fastening piece and the main body to be detachably connected.

12. The magnetic nose hair device according to claim 9, a plurality of grooves are defined in the blade cover.

13. The magnetic nose hair device according to claim 10, a supporting piece is arranged between the fastening piece and the main body.

14. The magnetic nose hair device according to claim 14, wherein the cutter head housing comprises a first housing and a second housing connected with each other, at least a part of the inner cutting knife extends inside the first housing.

15. The magnetic nose hair device according to claim 1, wherein a volume of the second housing is greater than that of the first housing.

16. A magnetic nose hair device, comprising a cutter head and a main body, wherein the cutter head comprises an inner cutting knife, and the cutter head is provided with a first magnetic piece, the main body is provided with a second magnetic piece, and the cutter head and the main body are magnetically and detachably connected together through the first magnetic piece and the second magnetic piece.

17. The magnetic nose hair device according to claim 16, the cutter head comprises a blade cover, the inner cutting knife is arranged inside the blade cover, a cavity is defined inside of the cutter head, a rotating shaft is arranged at the main body, and the rotating shaft extends out of the main body and passes through the cavity to connect with the inner cutting knife.

18. The magnetic nose hair device according to claim 16, wherein at least one of the first magnetic piece and the second magnetic piece is a magnet, and another one of the first magnetic piece and the second magnetic piece is a ferromagnetic metal.

19. The magnetic nose hair device according to claim 16, wherein the cutter head comprises a cutter head housing, two first magnetic pieces and two second magnetic pieces are arranged, and
the two first magnetic pieces are arranged symmetrically at a bottom end of the cutter head housing along an axis of a bottom opening of the cutter head housing.

20. A magnetic nose hair device, comprising a cutter head and a main body, wherein the cutter head comprises a cutter head housing and an inner cutting knife, and the cutter head housing is provided with a first connecting piece, the main body is provided with a second connecting piece, and the cutter head and the main body are detachably connected together through the first connecting piece and the second connecting piece.
